(19) United States
(12) Patent Application Publication
(10) Pub. No.: US 2007/0252306 A1
(43) Pub. Date: Nov. 1, 2007

(54) Synthetic Resin Composite for Molding, Method of Molding, and Molded Product

(76) Inventor: Masao Yamamoto, Tokyo (JP)

Correspondence Address: GREER, BURNS & CRAIN, 300 S WACKER DR, 25TH FLOOR, CHICAGO, IL, 60606, US

(21) Appl. No.: 11/596,095

(22) PCT Filed: Sep. 21, 2005
(86) PCT No.: PCT/JP05/17416

§ 371 Date: Nov. 9, 2006

(30) Foreign Application Priority Data
Jan. 14, 2005 (JP) 2005-008411

(51) Int. Cl. C08L 101/00

(52) U.S. Cl. 264/299; 524/847

(57) ABSTRACT

A synthetic resin composite for molding that has reduced molding shrinkage and that is suitable for producing a synthetic resin molding which is complicated, delicate, and highly precise. The molding resin composite is produced by mixing, in a specific proportion, any synthetic resin with a substance that has an elasticity such that when the volume compaction via pressure is 30% or higher, then the volume recovery will be 15% or higher. The substance will preferably be an elastic graphite in which the walls of the carbon layer surfaces in the graphite form many round spaces having an inner diameter substantially smaller than the molecules of the polymer constituting the synthetic resin.

### TECHNICAL FIELD

The present invention relates to a synthetic resin composite for molding, and specifically relates to a synthetic resin composite that has a low mold shrinkage during molding and is suitable for producing complex, elaborate, and highly precise products molded from synthetic resin such as electrical appliances, auto parts, office automation equipment components, and precision equipment components. The present invention also relates to a method of molding and a molded product using the synthetic resin.

### BACKGROUND ART

In general, synthetic resin is suitable for mass production due to its favorable moldability and it has been widely utilized in recent years as a molding material because it can be produced at low cost in a short time period, and it is possible to manufacture products with it that have a variety of properties. The molding methods of synthetic resin include extrusion molding, blow molding, and reaction molding; however, the most common method is injection molding, and the components produced by this method include electrical appliances, auto parts, office automation equipment components, and precision equipment components and the like.

In recent years there has been increasing demand for synthetic resin as a molding material in various fields; however, it is known that mold shrinkage occurs due to phase changes, crystallization, and thermal shrinkage with lowering temperature during the molding of synthetic resin. For that reason, the minimization of mold shrinkage by the blending of synthetic resin with various low shrinkage agents such as thermoplastic resin has been studied. When a thermoplastic resin, serving as a low shrinkage agent, is blended with a synthetic resin composite, low shrinkage can be achieved to a certain extent in the molded product; however, there is a problem in that the resulting heat resistance is not sufficient. Patent Document 1 discloses a low-shrinkage unsaturated polyester resin as a synthetic resin composite for molding with low shrinkage and good heat resistance. A molded product with low shrinkage during hardening and with high heat resistance can be produced from the resin in Patent Document 1 by blending an unsaturated polyester resin with A-B block copolymer.

Patent Document 1: Japanese Patent Application Publication No. H3-37257

### DISCLOSURE OF THE INVENTION

### Problems to be Solved by the Invention

The unsaturated polyester resin that is currently used for producing the above conventional resin mixture has problems such as its relatively low productivity, poor environment in the molding scene, and the difficulty in recycling the resin after use. Another problem is that the A-B block copolymer, an additive agent that serves as a low shrinkage agent, requires time and effort for preparation since it is produced from a raw material monomer through the processes of polymerization and purification.

The present invention is made in view of the above problems, and it is an object of the present invention to provide a synthetic resin composite for molding that is easy to produce, has a low mold shrinkage during molding, and is suitable for the manufacture of complex, elaborate, and highly precise products molded from synthetic resin.

### MEANS FOR SOLVING THE PROBLEMS

In order to achieve the above object, it is preferable that the synthetic resin composite for the molding of the present invention be a blending of any synthetic resin with a substance that has an elasticity with a volume recovery of 15% or higher when the volume compaction due to pressure is 30% or higher (hereinafter described as an elastic substance).

It is also preferable that the elastic substance be an elastic graphite and that in the elastic graphite, the inner diameter of many porosities (hereinafter referred to as pores) formed by the carbon layer surface wall be substantially smaller than the molecules of the polymer compound of the synthetic resin.

In addition, it is preferable that the elastic substance constitute 5-70 weight percent of the synthetic resin composite.

### EFFECT OF THE INVENTION

The synthetic resin composite to be used for molding of the present invention can be easily produced by only kneading a particular fraction of synthetic resin and an elastic substance with a commercial kneader or the like, wherein the elastic substance has a volume recovery of 15% or more when the volume compaction by pressure is 30% or more. An example of a preferable substance with this property is elastic graphite, which has pores inside formed on the carbon layer surface wall whose inner diameter is substantially smaller than the molecules of the polymer compound of the above synthetic resin. By adding a certain pressure at molding, the elastic substance blends to the synthetic resin composite, providing a molded product with a low mold shrinkage factor and a high dimensional accuracy.

### BRIEF DESCRIPTION OF THE DRAWINGS

FIG. 1 is a cross-sectional overview showing the volume compaction/recovery measurement apparatus in a state in which it is filled with filler;

FIG. 2 is a cross-sectional overview showing the filler volume compaction/recovery measurement apparatus in a loaded state;

FIG. 3 is a cross-sectional overview showing the filler volume compaction/recovery measurement apparatus in a state in which the load is removed; and

FIG. 4 is a graph showing the measurement results of the filler volume compaction/recovery.

### BEST MODE FOR CARRYING OUT THE INVENTION

In the following description, details of the present invention are set forth with reference to the drawings.

<Synthetic Resin>

Both thermoplastic synthetic resin and thermosetting synthetic resin can be used in the present invention. For example, the thermoplastic synthetic resin includes polypropylene resin, polycarbonate resin, polyacetal resin, and others, and the thermosetting synthetic resin includes phenol resin, epoxy resin, urea resin, melamine resin, and others.

<Filler>

The filler to be used can be an elastic substance in which, when a load that has compressed the filler volume under pressure by 30% or more is removed, the filler recovers 15% or more of its volume.

Elastic graphite has its inside composed of a number of circular spaces divided by walls of carbon layer surface; in other words, it has a sponge-like structure. For that reason, elastic graphite is known to have a high compaction/recovery and elasticity limit. Therefore, it is preferable that the above elastic substance be elastic graphite and that the inner diameter of the pores formed by the carbon layer surface wall in the elastic graphite be substantially smaller than the molecules of polymer compound of the above synthetic resin. The elastic graphite that best satisfies the above conditions is the elastic graphite manufactured by SUPERIOR GRAPHITE Co. under the product name “DESULCO”. The inner diameter of the pores of DESULCO is approximately 19.2 nm.

When producing a synthetic resin composite for molding using synthetic resin with extremely large molecules, 5000 nm for example, Koa Sekiyu Kabushiki Kaisha, Mitsui Mining Company, Limited joint development elastic graphite (product name “ELFITE”) can be used as an elastic graphite satisfying the above conditions. The inner diameter of the pores in “ELFITE” is approximately 1000-5000 nm.

In addition, the synthetic resin composite may contain a known additive agent as needed. The additive agent may include, for example, an antioxidant, a fire retardant, an antistatic agent, a curing agent, a colorant, various anti-degradation agents, and/or a reinforcement, among other things.

It should be noted that the method of generating the synthetic resin composite (the method for adding the above filler and additive agents to the synthetic resin) is not limited to a particular method. For example, if the quantity of the above filler and additive agent to be blended is small, a method such as dry blending may be selected, whereas if the quantity of the filler and additive agent to be blended is large, a method such as melt kneading may be selected. It is also possible to use a filler and additive agent that have been dispersed and blended to a high concentration and then diluted before molding.

### EXAMPLES

In the following description, further details of the present invention are set forth with reference to the embodiment described herein and comparative examples are given; however, these examples should not be construed in any way as limiting the invention.

[Measurement of Filler Volume Compaction/Recovery]

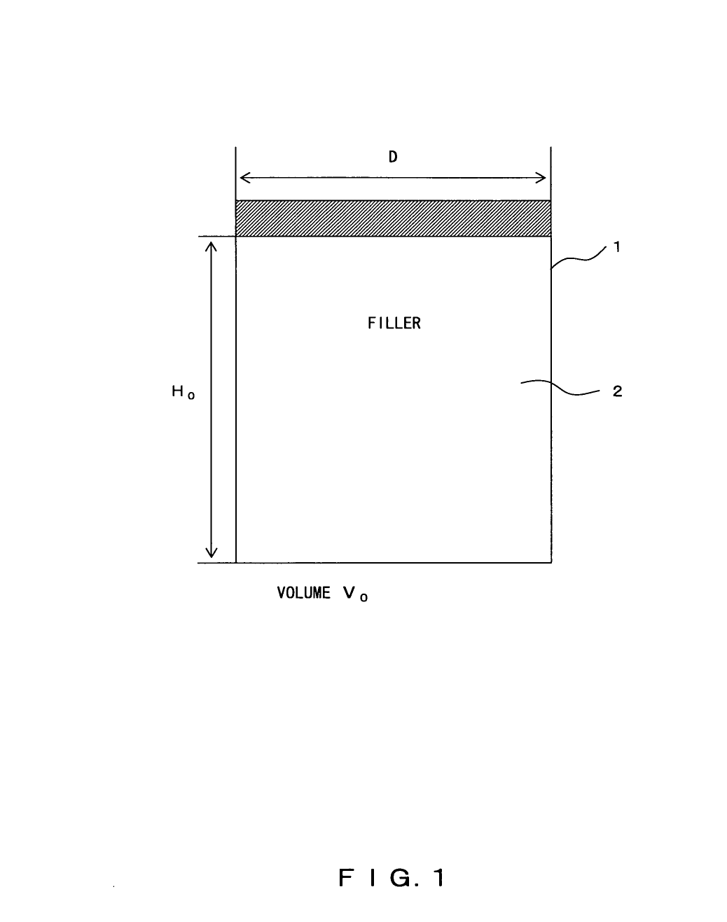

The measurement methods of the filler volume compaction/recovery used in the present examples are explained and comparative examples are given below with reference to FIGS. 1-3.

Used fillers; 1. elastic graphite (product name “DESULCO”) manufactured by SUPERIOR GRAPHITE Co.

2. graphite powder (product name “CPB”) manufactured by Nippon Graphite Industry Co., Ltd.

3. heavy calcium carbonate

4. Koa Sekiyu Kabushiki Kaisha, Mitsui Mining Company, Limited joint development elastic graphite (product name “ELFITE”)

FIG. 1 is a cross-sectional overview showing a volume compaction/recovery measurement apparatus in a state in which it is filled with filler. FIG. 1 is a diagram showing the no-load state, in which a cylinder 1 is filled with filler 2. The present example assumed that the inner diameter of the cylinder 1 was D=3.50 mm. First, the filler 2 was filled so that the height of the filler was 1-1.5 times greater than the inner diameter D. Next, a piston (not shown in the drawing) was inserted into the cylinder 1 and attached to a manual hand press not shown in the drawing by lightly pressing (of 1-2 kg by hand) it, and then the height of the filler H₀ was measured.

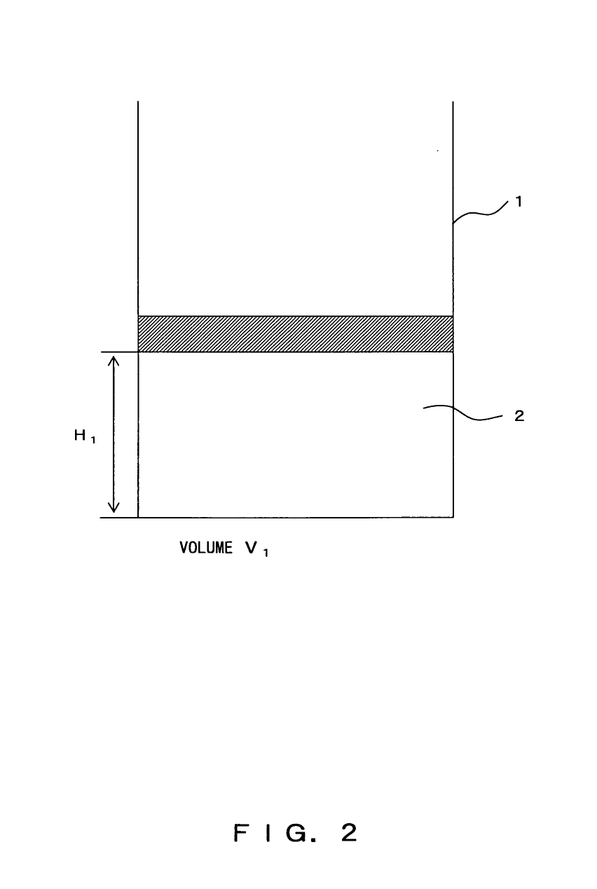

FIG. 2 is a cross-sectional overview showing the filler volume compaction/recovery measurement apparatus in the loaded state. FIG. 2 is a diagram showing the cylinder 1 filled with the filler 2 in the same manner as in FIG. 1, and with a certain load applied to it by using the manual hand press (not shown in the drawing). The height H₁ of the filler in this case was measured.

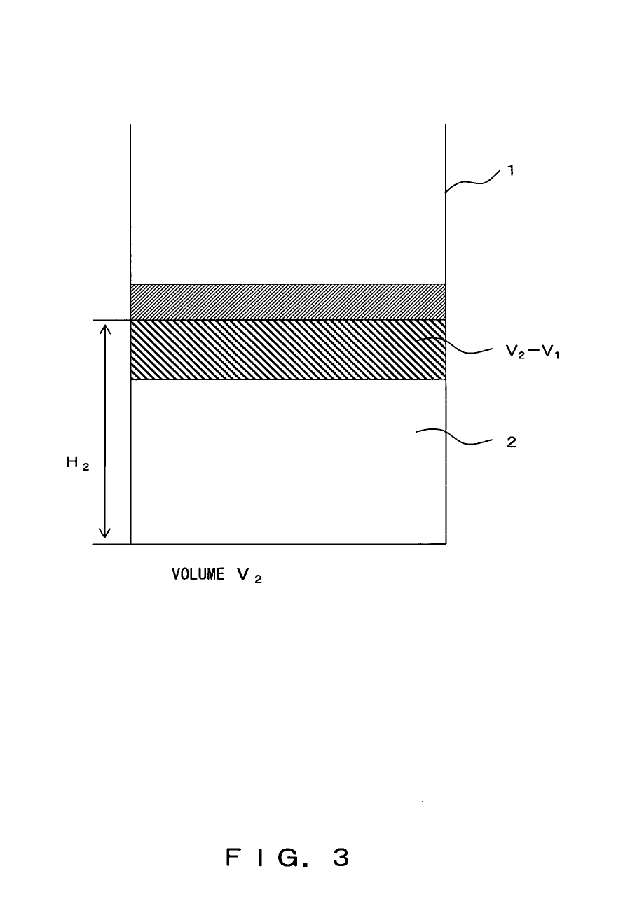

FIG. 3 is a cross-sectional overview showing the filler volume compaction/recovery measurement apparatus with the load removed. FIG. 3 is a diagram showing the cylinder 1 filled with the filler 2 in the same manner as in FIG. 1 and FIG. 2, and after being left for sufficient time period, e.g. 24 hours, after removing the load applied in FIG. 2. The filler height H₂ in this case was measured. From the value measured under the above conditions, the volume compaction C and the volume recovery E were calculated using equation (1) and equation (2) following, and the result is shown in Tables 1-4.

Note that in the present example, the synthetic resin composite produced by mixing filler with synthetic resin was molded by using injection molding equipment (product name “IS45P” manufactured by Toshiba Machine CO., Ltd.). The measured load needed to be from 15.289 MPa to 196.1 MPa, which was the upper limit of the injection pressure of the injection molding equipment, or higher, and therefore, the measurement was performed by applying a load of 203.857 MPa, as shown in Tables 1-4, so that results were obtained that simulated the molding pressure conditions, which were able to be set by the injection molding equipment used in the examples subsequent to Example 1.

TABLE 1

| | |
|---|---|
| | [Equation 1] |
| $VOLUME COMPACTION C ( \% ) = \frac{{V}_{0} - {V}_{1}}{{V}_{0}} \times 100 = \frac{( {H}_{0} - {H}_{1} )}{{H}_{0}} \times 100$ | |
| | [Equation 2] |
| $VOLUME RECOVERY E ( \% ) = \frac{{V}_{2} - {V}_{1}}{{V}_{0}} \times 100 = \frac{( {H}_{2} - {H}_{1} )}{{H}_{0}} \times 100$ | |

| FILLER | ELASTIC GRAPHITE MANUFACTURED BY | | | | | |
|---|---|---|---|---|---|---|
| | SUPERIOR GRAPHITE CO. (PRODUCT NAME | | | | | |
| | “DESULCO”) | | | | | |
| LOAD (MPa) | 15.289 | 30.578 | 50.963 | 101.928 | 152.892 | 203.857 |
| H₀ (mm) | 4.52 | 4.36 | 4.25 | 4.26 | 4.74 | 4.63 |
| H₁ (mm) | 3.13 | 2.41 | 2.05 | 1.68 | 1.81 | 1.64 |
| H₂ (mm) | 3.89 | 3.57 | 3.28 | 3.11 | 3.38 | 3.12 |
| VOLUME | 30.75 | 44.72 | 51.76 | 60.56 | 61.81 | 64.57 |
| COM- | | | | | | |
| PACTION | | | | | | |
| C (%) | | | | | | |
| VOLUME | 16.81 | 26.60 | 28.94 | 33.56 | 33.12 | 31.96 |
| RECOVERY | | | | | | |
| E (%) | | | | | | |

TABLE 2

| FILLER | GRAPHITE POWDER MANUFACTURED | | | | | |
|---|---|---|---|---|---|---|
| | BY NIPPON GRAPHITE INDUSTRY | | | | | |
| | CO., LTD. (PRODUCT NAME “CPB”) | | | | | |
| LOAD (MPa) | 15.289 | 30.578 | 50.963 | 101.928 | 152.892 | 203.857 |
| H₀ (mm) | 4.51 | 4.71 | 4.39 | 4.35 | 4.22 | 4.48 |
| H₁ (mm) | 2.37 | 2.32 | 1.96 | 1.65 | 1.42 | 1.63 |
| H₂ (mm) | 2.58 | 2.56 | 2.19 | 1.88 | 1.63 | 1.87 |
| VOLUME | 47.75 | 50.74 | 55.35 | 62.06 | 66.35 | 63.60 |
| COM- | | | | | | |
| PACTION | | | | | | |
| C (%) | | | | | | |
| VOLUME | 4.65 | 5.09 | 5.23 | 5.28 | 4.97 | 5.35 |
| RECOVERY | | | | | | |
| E (%) | | | | | | |

TABLE 3

| FILLER | HEAVY CALCIUM CARBONATE POWDER | | | | | |
|---|---|---|---|---|---|---|
| LOAD (MPa) | 15.289 | 30.578 | 50.963 | 101.928 | 152.892 | 203.857 |
| H₀ (mm) | 4.15 | 4.09 | 4.26 | 4.56 | 4.68 | 4.74 |
| H₁ (mm) | 3.64 | 3.44 | 3.49 | 3.29 | 3.47 | 3.34 |
| H₂ (mm) | 3.71 | 3.55 | 3.62 | 3.45 | 3.66 | 3.54 |
| VOLUME | 12.28 | 15.89 | 18.07 | 27.85 | 25.85 | 29.53 |
| COM- | | | | | | |
| PACTION | | | | | | |
| C (%) | | | | | | |
| VOLUME | 1.68 | 2.68 | 3.05 | 3.50 | 4.05 | 4.21 |
| RECOVERY | | | | | | |
| E (%) | | | | | | |

TABLE 4

| FILLER | KOA SEKIYU KABUSHIKI KAISHA, MITSUI | | | | | |
|---|---|---|---|---|---|---|
| | MINING COMPANY, LIMITED JOINT | | | | | |
| | DEVELOPMENT ELASTIC GRAPHITE | | | | | |
| | (PRODUCT NAME “ELFITE”) | | | | | |
| LOAD (MPa) | 15.289 | 30.578 | 50.963 | 101.928 | 152.892 | 203.857 |
| H₀ (mm) | 4.41 | 4.33 | 4.15 | 4.41 | 4.36 | 4.67 |
| H₁ (mm) | 2.64 | 1.92 | 1.38 | 1.08 | 0.91 | 0.88 |
| H₂ (mm) | 3.82 | 3.63 | 3.27 | 3.37 | 3.32 | 3.45 |
| VOLUME | 40.13 | 55.65 | 66.74 | 75.51 | 79.12 | 81.15 |
| COM- | | | | | | |
| PACTION | | | | | | |
| C (%) | | | | | | |
| VOLUME | 26.75 | 39.49 | 45.54 | 51.92 | 55.27 | 55.03 |
| RECOVERY | | | | | | |
| E (%) | | | | | | |

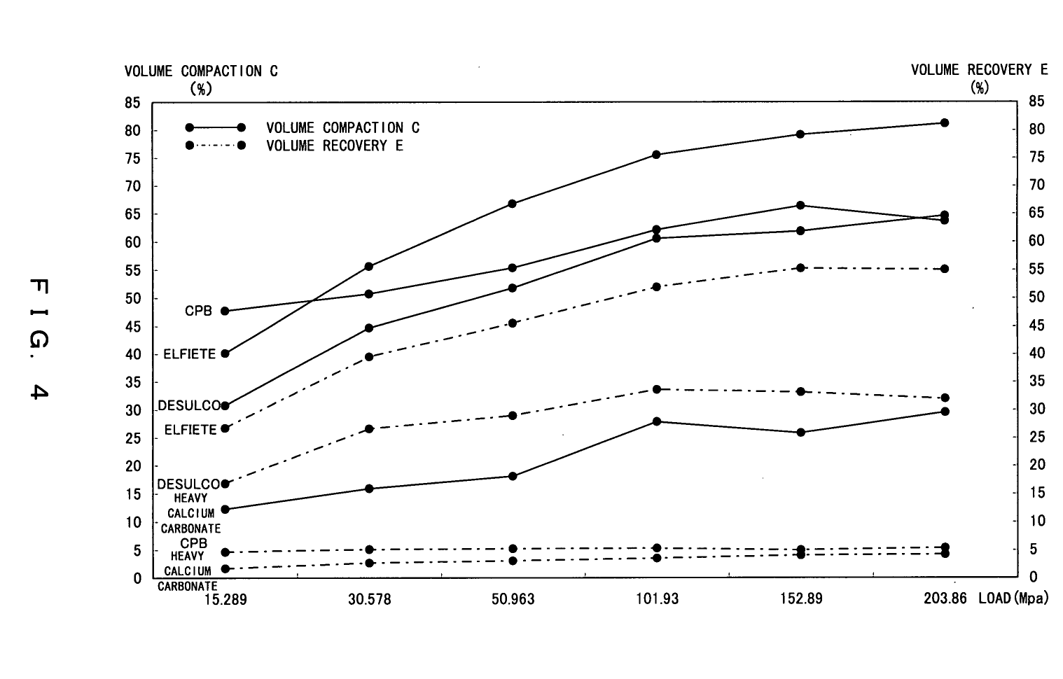

The results of the above Tables 1-4 are shown in FIG. 4. From FIG. 4, it was found that the volume compaction C and the volume recovery E were high in the elastic graphite “DESULCO” and “ELFITE” and that they had high elasticity. “CPB” and heavy calcium carbonate had a low volume recovery E and the volume recovery changed very little even when the load was increased.

### Example 1

In the present example, the following synthetic resin and filler were used.

(1) Production of Synthetic Resin Composite for Molding

synthetic resin; polypropylene resin (product name “J-allomer EG110” manufactured by Japan Polyolefin Co., Ltd.)

filler; elastic graphite (product name “DESULCO”) manufactured by SUPERIOR GRAPHITE Co.

After crushing the filler so as to have a particle size of 0.1 mm or less and dry blending the synthetic resin and the filler, a kneader (product name “S-1 KRC” manufactured by Kurimoto, Ltd.) was used for kneading (with a barrel temperature of 240° C.) and the obtained composition was used after it had been crushed.

(2) Molding of Synthetic Resin for Molding

<Molding Conditions>

molding temperature 240° C.
mold temperature 40° C.
injection time 10 seconds
cooling time 10 seconds
injection pressure shown in Table 5 below

Using an injection molding machine (product name “IS45P” manufactured by Toshiba Machine Co., Ltd.), the produced composition was supplied to a mold via a nozzle under the above conditions and was molded by pressure molding, and then a tabular molded product (test specimen) was obtained. The mold used for the molding was tabular with a vertical length of 40.00 mm, a horizontal length of 25.00 mm, a thickness of 2.50 mm, and rounding portion at the four corners of 3.0 mm, and it had a filling inlet for filling one side face of the minor axis of the mold with the above produced resin. The size of the filling inlet was 4.00 mm×2.00 mm.

(3) Calculation of Mold Shrinkage Factor

After leaving the molded product (test specimen) for 24 hours or longer, its dimensions were measured, and the mold shrinkage factor was calculated using equation (3).

TABLE 5

| | |
|---|---|
| | [Equation 3] |
| $MOLDSHRINKING FACTOR S ( \% ) = \frac{\begin{matrix}( DIMENSION OF INNER MOLD ) - \\ ( DIMENSION OF MOLDED PRODUCT )\end{matrix}}{( DIMENSION OF INNER MOLD )} \times 100$ | |

| SYNTHETIC RESIN | | POLYPROPYLENE (MANUFACTURED BY JAPAN POLYOLEFIN | | | | | | | |
|---|---|---|---|---|---|---|---|---|---|
| | | CO., LTD.; PRODUCT NAME “J-ALLOMER EG110”) | | | | | | | |
| FILLER | | ELASTIC GRAPHITE MANUFACTURED BY SUPERIOR GRAPHITE. | | | | | | | |
| | | (PRODUCT NAME “DESULCO”) | | | | | | | |
| RATIO OF | | 20 | 20 | 20 | 20 | 20 | 70 | 70 | 70 |
| FILLER (WT %) | | | | | | | | | |
| INJECTION PRESSURE | | 84.1 | 112.1 | 140.1 | 168.1 | 182.1 | 84.1 | 98.1 | 112.1 |
| (MPa) | | | | | | | | | |
| MOLDED | LENGTH | 39.77 | 39.90 | 40.00 | 40.04 | 40.05 | 39.99 | 40.01 | 40.06 |
| PRODUCT | WIDTH | 24.82 | 24.92 | 25.00 | 25.02 | 25.02 | 24.99 | 25.02 | 25.08 |
| DIMENSIONS | | | | | | | | | |
| (mm) | | | | | | | | | |
| MOLD | LENGTH | 0.575 | 0.250 | 0.000 | −0.100 | −0.125 | 0.025 | −0.025 | −0.150 |
| SHRINKAGE | WIDTH | 0.720 | 0.320 | 0.000 | −0.080 | −0.080 | 0.040 | −0.080 | −0.320 |
| FACTOR S | AVERAGE | 0.648 | 0.285 | 0.000 | −0.090 | −0.103 | 0.033 | −0.053 | −0.235 |
| (%) | | | | | | | | | |

From the results shown in Table 5, it can be seen that the mold shrinkage factor varied depending on the injection pressure. Further, in the present example, when the ratio of the filler in the composition was 20 weight percent, the mold shrinkage factor became 0 when the injection pressure was 140.1 MPa, and when the injection pressure was further increased, the mold shrinkage factor became negative; in other words, a molded product larger than the inner dimension of the mold was obtained.

### Comparative Example 1

synthetic resin; the same resin as the polypropylene resin used in Example 1 was used
filler; not used

The production of the above synthetic resin composite for molding and the molding of the obtained composition were performed in the same manner as in Example 1, and the results are shown in Table 6.

TABLE 6

| SYNTHETIC RESIN | | POLYPROPYLENE (MANUFACTURED BY | | | | |
|---|---|---|---|---|---|---|
| | | JAPAN POLYOLEFIN CO., LTD.; | | | | |
| | | PRODUCT NAME “J-ALLOMER EG110”) | | | | |
| FILLER | | — | | | | |
| RATIO OF | | 0 | 0 | 0 | 0 | 0 |
| FILLER (WT %) | | | | | | |
| INJECTION | | 84.1 | 112.1 | 140.1 | 168.1 | 196.1 |
| PRESSURE (MPa) | | | | | | |
| MOLDED | LENGTH | 39.53 | 39.65 | 39.70 | 39.76 | 39.80 |
| PRODUCT | WIDTH | 24.69 | 24.75 | 24.77 | 24.80 | 24.83 |
| DIMEN- | | | | | | |
| SIONS | | | | | | |
| (mm) | | | | | | |
| MOLD | LENGTH | 1.175 | 0.875 | 0.750 | 0.600 | 0.500 |
| SHRINK- | WIDTH | 1.240 | 1.000 | 0.920 | 0.800 | 0.680 |
| AGE | AVER- | 1.208 | 0.938 | 0.835 | 0.700 | 0.590 |
| FACTOR S | AGE | | | | | |
| (%) | | | | | | |

### Comparative Example 2

synthetic resin; the same resin as the polypropylene resin used in Example 1 was used.
filler; graphite powder (product name “CPB”) manufactured by Nippon Graphite Industry Co., Ltd.

The production of the synthetic resin composite for molding using the above synthetic resin and filler and the molding of the obtained composite resin were performed in the same manner as in Example 1, and the results are shown in Table 7.

TABLE 7

| SYNTHETIC RESIN | | POLYPROPYLENE | | | |
|---|---|---|---|---|---|
| | | (MANUFACTURED BY JAPAN | | | |
| | | POLYOLEFIN CO., LTD.; PRODUCT | | | |
| | | NAME “J-ALLOMER EG110”) | | | |
| FILLER | | GRAPHITE POWDER | | | |
| | | MANUFACTURED BY NIPPON | | | |
| | | GRAPHITE INDUSTRY CO., | | | |
| | | LTD. (PRODUCT NAME “CPB”) | | | |
| RATIO OF | | 30 | 30 | 30 | 30 |
| FILLER (WT %) | | | | | |
| INJECTION PRESSURE | | 112.1 | 140.1 | 168.1 | 182.1 |
| (MPa) | | | | | |
| MOLDED | LENGTH | 39.86 | 39.90 | 39.93 | 39.95 |
| PRODUCT | WIDTH | 24.88 | 24.90 | 24.91 | 24.91 |
| DIMENSIONS | | | | | |
| (mm) | | | | | |
| MOLD | LENGTH | 0.350 | 0.250 | 0.175 | 0.125 |
| SHRINKAGE | WIDTH | 0.480 | 0.400 | 0.360 | 0.360 |
| FACTOR S (%) | AVERAGE | 0.415 | 0.325 | 0.268 | 0.243 |

### Comparative Example 3

synthetic resin; the same resin as the polypropylene resin used in Example 1 was used.
filler; commercial heavy calcium carbonate powder

The production of the synthetic resin composite for molding using the above synthetic resin and filler and the molding of the obtained composite resin were performed in the same manner as in Example 1, and the results are shown in Table 8.

TABLE 8

| SYNTHETIC RESIN | | POLYPROPYLENE | | | |
|---|---|---|---|---|---|
| | | (MANUFACTURED BY JAPAN | | | |
| | | POLYOLEFIN CO., LTD.; | | | |
| | | PRODUCT NAME “J-ALLOMER | | | |
| | | EG110”) | | | |
| FILLER | | HEAVY CALCIUM CARBONATE | | | |
| | | POWDER | | | |
| RATIO OF | | 30 | 30 | 30 | 30 |
| FILLER (WT %) | | | | | |
| INJECTION | | 112.1 | 140.1 | 168.1 | 196.1 |
| PRESSURE (MPa) | | | | | |
| MOLDED | LENGTH | 39.76 | 39.82 | 39.92 | 39.98 |
| PRODUCT | WIDTH | 24.80 | 24.84 | 24.86 | 24.88 |
| DIMENSIONS | | | | | |
| (mm) | | | | | |
| MOLD | LENGTH | 0.600 | 0.450 | 0.200 | 0.050 |
| SHRINKAGE | WIDTH | 0.800 | 0.640 | 0.560 | 0.480 |
| FACTOR S (%) | AVERAGE | 0.700 | 0.545 | 0.380 | 0.265 |

### Comparison Example 4

synthetic resin; the same resin as the polypropylene resin used in Example 1 was used.
filler; Koa Sekiyu Kabushiki Kaisha, Mitsui Mining Company, Limited joint development elastic graphite (product name “ELFITE”)

The production of the synthetic resin composite for molding using the above synthetic resin and filler and the molding of the obtained composite resin were performed in the same manner as in Example 1, and the results are shown in Table 9.

TABLE 9

| SYNTHETIC RESIN | | POLYPROPYLENE | | | |
|---|---|---|---|---|---|
| | | (MANUFACTURED BY JAPAN | | | |
| | | POLYOLEFIN CO., LTD.; | | | |
| | | PRODUCT NAME “J-ALLOMER | | | |
| | | EG110”) | | | |
| FILLER | | KOA SEKIYU KABUSHIKI KAISHA, | | | |
| | | MITUI MINING COMPANY, | | | |
| | | LIMITED JOINT | | | |
| | | DEVELOPMENT ELASTIC | | | |
| | | GRAPHITE (PRODUCT NAME | | | |
| | | “ELFITE”) | | | |
| RATIO OF | | 30 | 30 | 30 | 30 |
| FILLER (WT %) | | | | | |
| INJECTION PRESSURE | | 112.1 | 140.1 | 168.1 | 196.1 |
| (MPa) | | | | | |
| MOLDED | LENGTH | 39.75 | 39.78 | 39.86 | 39.90 |
| PRODUCT | WIDTH | 24.81 | 24.85 | 24.90 | 24.93 |
| DIMENSIONS | | | | | |
| (mm) | | | | | |
| MOLD | LENGTH | 0.625 | 0.550 | 0.350 | 0.250 |
| SHRINKAGE | WIDTH | 0.760 | 0.600 | 0.400 | 0.280 |
| FACTOR S (%) | AVERAGE | 0.693 | 0.575 | 0.375 | 0.265 |

As is obvious from Tables 6-9, the mold shrinkage factor was lowered by increasing the injection pressure; however, the mold shrinkage factor was still higher than the result in Example 1, and a molded product with a high dimensional accuracy could not be obtained.

This was because if “CPB” or the heavy calcium carbonate powder was used as the filler, as is clear from Table 2, Table 3, and FIG. 4 above, the volume recovery E was too small, indicating that the elasticity of the filler was not sufficient.

On the other hand, the minimum molecular size of the polymer compound used as the synthetic resin was 100-200 nm in the case of polyethylene resin. In addition, as described above, the inner diameter of the pores formed by the carbon layer surface wall in “ELFITE” was 1000-5000 nm. Therefore, it is probable that since the inner diameter of the pores in “ELFITE” was larger than the molecules of the polymer compound of the synthetic resin used in the present example, the synthetic resin moved into the pores of the “ELFITE” when they were blended and the “ELFITE” thus lost its volume compaction/recovery function and a molded product with a high dimensional accuracy could not be obtained.

As described above, since it is preferable that the filler blended in the synthetic resin be elastic graphite and that in the elastic graphite the inner diameter of the pores formed by the carbon layer surface wall be substantially smaller than the molecules of the polymer compound of the above synthetic resin, the present example employed “DESULCO”. However, when manufacturing synthetic resin composite for molding using a synthetic resin made from a polymer compound with extremely large molecules (5000 nm for example), it is possible to use “ELFITE” etc. as the elastic graphite with elasticity so as to satisfy the above conditions.

### Example 2

In this example, the following synthetic resin and filler were employed.

(1) Production of Synthetic Resin Composite for Molding

synthetic resin; polycarbonate resin (product name “Iupilon S3000” manufactured by Mitsubishi Engineering-Plastics Corporation)

filler; elastic graphite (product name “DESULCO” manufactured by SUPERIOR GRAPHITE Co.)

The same method as is shown in Example 1 was employed for producing the synthetic resin composite with the exception that the barrel temperature in the kneader was changed to 280° C.

(2) Molding of Synthetic Resin Composite for Molding

<Molding Conditions>

molding temperature 280° C.
mold temperature 90° C.
injection pressure shown in Table 10 below
   Other than the above changes in the molding conditions, the molding of the synthetic resin composite was performed in the same manner as that shown in Example 1.
   (3) Calculation of Mold Shrinkage Factor

The mold shrinkage factor of the produced molded product (test specimen) was calculated by using equation (3) above, and the result is shown in Table 10.

TABLE 10

| SYNTHETIC RESIN | | POLYCARBONATE RESIN (MANUFACTURED BY MITSUBISHI ENGINEERING-PLASTICS CORPORATION; | | | | | | | | | | | |
|---|---|---|---|---|---|---|---|---|---|---|---|---|---|
| | | PRODUCT NAME ┌IUPILON S3000┘) | | | | | | | | | | | |
| FILLER | | ELASTIC GRAPHITE MANUFACTURED BY SUPERIOR GRAPHITE CO. (PRODUCT NAME ┌DESULCO┘) | | | | | | | | | | | |
| RATIO OF | | 5 | 5 | 5 | 5 | 10 | 10 | 10 | 10 | 20 | 20 | 20 | 20 |
| FILLER | | | | | | | | | | | | | |
| (WT %) | | | | | | | | | | | | | |
| INJECTION PRESSURE | | 112.1 | 140.1 | 168.1 | 196.1 | 112.1 | 140.1 | 168.1 | 196.1 | 112.1 | 140.1 | 168.1 | 196.1 |
| (MPa) | | | | | | | | | | | | | |
| MOLDED | LENGTH- | 39.85 | 39.9 | 39.95 | 39.99 | 39.89 | 39.92 | 39.97 | 40 | 39.92 | 39.97 | 40 | 40.03 |
| PRODUCT | WIDE | | | | | | | | | | | | |
| DIMENSION | CROSS- | 24.91 | 24.94 | 24.97 | 24.99 | 24.92 | 24.94 | 24.96 | 25 | 24.96 | 24.97 | 25 | 25.04 |
| (mm) | WIDE | | | | | | | | | | | | |
| MOLD | LENGTH- | 0.375 | 0.25 | 0.125 | 0.025 | 0.275 | 0.2 | 0.075 | 0 | 0.2 | 0.075 | 0 | −0.075 |
| SHRINKAGE | WIDE | | | | | | | | | | | | |
| FACTOR S (%) | CROSS- | 0.36 | 0.24 | 0.12 | 0.04 | 0.32 | 0.24 | 0.16 | 0 | 0.16 | 0.12 | 0 | −0.16 |
| | WIDE | | | | | | | | | | | | |
| | AVERAGE | 0.368 | 0.245 | 0.123 | 0.033 | 0.298 | 0.22 | 0.118 | 0 | 0.18 | 0.098 | 0 | −0.118 |

### Comparative Example 5

synthetic resin; the same polycarbonate resin used in Example 2 was used.

filler; not used

Production of the synthetic resin composite for molding using the above synthetic resin and filler and the molding of the obtained composition were performed in the same manner as in Example 2. As is clear from Table 11, the mold shrinkage factor was lowered by increasing the injection pressure; however, the mold shrinkage factor was still higher than the result in Example 1, and a molded product with a higher dimensional accuracy could not be obtained.

TABLE 11

| SYNTHETIC RESIN | | POLYCARBONATE RESIN | | | |
|---|---|---|---|---|---|
| | | (MITSUBISHI ENGINEERING- | | | |
| | | PLASTICS; PRODUCT NAME | | | |
| | | “IUPILON S3000”) | | | |
| FILLER | | — | | | |
| RATIO OF | | 0 | 0 | 0 | 0 |
| FILLER (WT %) | | | | | |
| INJECTION | | 112.1 | 140.1 | 168.1 | 196.1 |
| PRESSURE (MPa) | | | | | |
| MOLDED | LENGTH | 39.86 | 39.89 | 39.92 | 39.96 |
| PRODUCT | WIDTH | 24.90 | 24.93 | 24.95 | 24.98 |
| DIMENSIONS | | | | | |
| (mm) | | | | | |
| MOLD | LENGTH | 0.350 | 0.275 | 0.200 | 0.100 |
| SHRINKAGE | WIDTH | 0.400 | 0.280 | 0.200 | 0.080 |
| FACTOR S (%) | AVERAGE | 0.375 | 0.278 | 0.200 | 0.090 |

### Example 3

In this example, the following synthetic resin and filler were employed.

(1) Production of Synthetic Resin Composite for Molding

synthetic resin; polyacetal resin (product name “Duracon TD-25” manufactured by Polyplastics Co., Ltd.)

filler; elastic graphite (product name “DESULCO” manufactured by SUPERIOR GRAPHITE Co.)

The same method shown in Example 1 was employed for producing the synthetic resin composite, with the exception that the barrel temperature in the kneader was changed to 200° C.

(2) Molding of Synthetic Resin Composite for Molding

<Molding Conditions>

molding temperature 200° C.
injection pressure shown in Table 12 below
   Other than the above change in the molding conditions, the molding of synthetic resin composite was performed using the same method as that shown in Example 1.
   (3) Calculation of Mold Shrinkage Factor

The mold shrinkage factor of the molded product (test specimen) was calculated by using the above equation (3), and the result is shown in Table 12.

TABLE 12

| SYNTHETIC RESIN | | POLYACETAL RESIN | | |
|---|---|---|---|---|
| | | (MANUFACTURED BY | | |
| | | POLYPLASTICS CO., LTD.; | | |
| | | PRODUCT NAME “DURACON | | |
| | | TD-25”) | | |
| FILLER | | ELASTIC GRAPHITE | | |
| | | MANUFACTURED BY SUPERIOR | | |
| | | GRAPHITE CO. (PRODUCT | | |
| | | NAME “DESULCO”) | | |
| RATIO OF | | 30 | 30 | 30 |
| FILLER (WT %) | | | | |
| INJECTION | | 140.1 | 168.1 | 196.1 |
| PRESSURE (MPa) | | | | |
| MOLDED | LENGTH | 39.91 | 39.95 | 40.05 |
| PRODUCT | WIDTH | 24.97 | 24.99 | 25.08 |
| DIMENSIONS | | | | |
| (mm) | | | | |
| MOLD | LENGTH | 0.225 | 0.125 | −0.125 |
| SHRINKAGE | WIDTH | 0.120 | 0.040 | −0.320 |
| FACTOR S (%) | AVERAGE | 0.173 | 0.083 | −0.223 |

### Comparative Example 6

synthetic resin; the same polyacetal resin used in Example 3 is used
filler; not used

Production of the synthetic resin composite for molding using the above synthetic resin and filler and the molding of the obtained composition were performed in the same manner as in Example 3. As is clear from Table 13, the mold shrinkage factor was lowered by increasing the injection pressure; however compared with the result of Example 3, the mold shrinkage factor was still higher, and a molded product with a higher dimensional accuracy could not be obtained.

TABLE 13

| SYNTHETIC RESIN | | POLYACETAL | | |
|---|---|---|---|---|
| | | (MANUFACTURED BY | | |
| | | POLYPLASTICS CO., LTD.; | | |
| | | PRODUCT NAME “DURACON | | |
| | | TD-25”) | | |
| FILLER | | — | | |
| RATIO OF FILLER | | 0 | 0 | 0 |
| (WT %) | | | | |
| INJECTION | | 140.1 | 168.1 | 196.1 |
| PRESSURE (MPa) | | | | |
| MOLDED | LENGTH | 39.70 | 39.76 | 39.80 |
| PRODUCT | WIDTH | 24.82 | 24.84 | 24.86 |
| DIMENSIONS | | | | |
| (mm) | | | | |
| MOLD | LENGTH | 0.750 | 0.600 | 0.500 |
| SHRINKAGE | WIDTH | 0.720 | 0.640 | 0.560 |
| FACTOR S (%) | AVERAGE | 0.735 | 0.620 | 0.530 |

As described above, the synthetic resin composite for molding of the present invention can be easily produced by only kneading a particular fraction of the synthetic resin with an elastic substance by a commercial kneader or the like, wherein the elastic substance has a volume recovery of 15% or more when the volume compaction by pressure is 30% or more. The elastic substance would preferably be elastic graphite, which has pores inside of it and formed by a carbon layer surface wall and their inner diameter is substantially smaller than the molecules of the polymer compound of the above synthetic resin. By adding a certain pressure at molding, the elastic substance blended with the synthetic resin provides a molded product with a low mold shrinkage factor and a high dimensional accuracy. In addition, it is also possible to change the dimensions of the molded product freely within a certain range by adjusting the pressure added in the molding process.

The synthetic resin for molding of the present invention is molded to become mechanical components in computers and office automation equipment, the bodies of precision instruments (such as cameras), lens barrels, and other sliding components/mechanical components such as gears, bearings, cams etc., and can be used as a part of products including machines, equipment and devices.

1. A synthetic resin composite for molding with a small shrinkage factor with respect to the mold during molding, consisting of:
a synthetic resin without elastomer; and
an elastic graphite being mixed with the synthetic resin, and having a volume recovery elasticity of 15% or higher when a volume compaction due to a prescribed pressurization is 30% or higher, and wherein:
the synthetic resin for molding has the elastic graphite having an elasticity in the range of 5-70 weight percent.

2. The synthetic resin according to claim 1, wherein
the substance with the elastic feature is the elastic graphite, and
the inner diameter of a plurality of spaces formed by the carbon layer surface wall in the elastic graphite is substantially smaller than the molecules of a polymer compound of the synthetic resin.

3. A molded product molded from the synthetic resin composite for molding according to claim 1 or claim 2.

4. A machine, an instrument, or a device manufactured by using the molded product according to claim 3.

5. A molding method using a synthetic resin composite for molding that has a small shrinkage factor with respect to a mold used for molding, comprising:
mixing synthetic resin without elastomer and elastic graphite having a volume recovery elasticity of 15% or higher when the volume compaction due to a prescribed pressurization is 30% or higher, wherein the elastic graphite with an elasticity blended within the range of 5-70 weight percent;
supplying the synthetic resin composite for molding produced by the mixing step into a mold; and
pressing the synthetic resin composite in the mold in a molding process to mold, and thereby obtaining a molded product.
